(19) United States
(12) Patent Application Publication
(10) Pub. No.: US 2009/0313204 A1
(43) Pub. Date: Dec. 17, 2009

(54) SAMPLE-BASED ROBUST INFERENCE FOR DECISION SUPPORT SYSTEM

(75) Inventor: Kees Van Zon, Cold Spring, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,475

(22) PCT Filed: Jul. 17, 2007
(86) PCT No.: PCT/IB07/52848

§ 371 Date: Jan. 28, 2009

Related U.S. Application Data
(60) Provisional application No. 60/820,804, filed on Jul. 31, 2006.

(51) Int. Cl. G06N 5/04

(52) U.S. Cl. 706/52

(57) ABSTRACT

The present invention deals with sampling-based robust inference for decision support systems (DSS). The invention relates to a method of operating a decision support system comprising at least one Bayesian network, to a decision support system and to a computer program product for implementing the system. The system comprising at least one Bayesian network (1), comprising a plurality of nodes (2, 20, 21), each node associated with parameters (4, 200, 210) expressing prior probabilities. At least a subset of the parameters stores a value range (6), and a set of probabilities of interest are calculated based on the parameters.

### FIELD OF THE INVENTION

The present invention relates to a method of operating a decision support system comprising at least one Bayesian network, moreover the invention relates to a decision support system and a computer program product.

### BACKGROUND OF THE INVENTION

Decision Support Systems (DSS) are a class of information processing systems that aim at supporting humans with making decisions when solving complicated problems. They are applied in many fields, including medical diagnostics, IC design, business, and finance.

Bayesian networks (BN) are a subclass of DSS's that can be applied when a problem can be described as a set of causal relationships in which events cause effects with certain probabilities. More particularly, they are executable graphical representations of the joint probability distribution (JPD) function of the random variables that constitute the problem set. A BN is a representation of the probabilistic relationships among events that characterize a problem. Each event, or variable, can take on one of a mutually exclusive and exhaustive set of possible states. A BN is expressed as an acyclic-directed graph comprising nodes, each node representing the event or variable.

Bayesian networks are a paradigm for decision making under uncertainty. They model a problem as probabilistic relationships between uncertain or random variables that represent the events that characterize the problem. A certain event can cause other events with a certain (conditional) probability. These parameters are usually taken to be fixed and well defined, but in practice, they are typically only known with a certain accuracy. This leads to a “second order uncertainty”, namely, the uncertainty about the parameters that describe relationships between uncertain variables.

The confidence in recommendations made by a Bayesian network depends on how well the parameters assigned to each node match reality. These parameters are often hard to establish with high precision, so each parameter has an inherent uncertainty. The uncertainties of all parameters involved in inference propagate to the output probabilities (the posterior probabilities of interest), causing uncertainty about the numbers that the Bayesian network provides to the user or to any (sub)system that uses these output probabilities. Establishing these uncertainties in the probabilities of interest is called robust inference.

The published patent application US 2005/0038671 discloses a method for mapping and identifying entity information in a system that includes a database. The system compares the attributes of the client entity with each of the system entities stored in the system database. Based on the results of the comparison, a score is calculated for the relevance between the client entity and each entity stored in the system. To perform this calculation, a multi-membership Bayesian function (MMBF) is used. The MMBF utilizes positive, negative and neutral contributions to said score depending on the results of said comparing step. Once the scores are computed, they are classified into three confidence zones based on predetermined threshold values.

The inventor of the present invention has appreciated that an improved means of handling uncertainties in a Bayesian network would be advantageous.

### SUMMARY OF THE INVENTION

Accordingly, the invention preferably seeks to mitigate, alleviate or eliminate one or more disadvantages of the prior art singly or in any combination. In particular, it may be seen as an object of the present invention to provide a way of handling uncertainties in the parameters of a Bayesian network in a simple and efficient manner.

This object and several other objects are obtained in a first aspect of the invention by providing a method of operating a decision support system, the system comprising:
at least one Bayesian network, the at least one Bayesian network comprising a plurality of nodes, each node associated with parameters expressing prior probabilities; wherein at least a subset of the parameters stores a value range; and wherein a set of probabilities of interest are calculated based on the parameters.

The upper and lower bounds of the uncertainty in a probability of interest can be calculated mathematically for certain classes of uncertainty distributions, but these classes are not necessarily of interest or the calculations involved may be intractable.

The present disclosure describes an advantageous solution for robust inference that is simple, always converges, and is versatile in that it can be used, or implemented so that it can be used with most standard BN inference engines. The method of the present invention may be implemented by use of a standard inference algorithm. A solution is thereby provided that allows decision makers or (sub)systems to take the uncertainty of probabilities of interest into account and thereby make more informed decisions or take more appropriate actions.

In advantageous embodiments, a value range is stored for each of at least a subset of the parameters, each value range representing the uncertainty of the corresponding parameter.

In advantageous embodiments, the uncertainty of each of the probabilities of interest is determined by calculating the probabilities of interest for multiple sets of parameter values such as for at least a first and second set of values, and determining each probability of interest across these multiple sets. This approach is referred to as sampling-based, where each sample is one of the multiple sets of parameter values. The value of each parameter in each sample may be chosen at random or can be chosen by a search algorithm.

In another aspect of the invention there is provided a decision support system comprising
a processor;
a memory having executable instructions stored therein;
at least one Bayesian network stored in the memory, the at least one Bayesian network comprising a plurality of nodes, each node associated with parameters expressing prior probabilities; wherein at least a subset of the parameters stores a value range;
wherein the processor, in response to instructions calculates a set of probabilities of interest based on the parameters.

The instructions may be user instructions and/or instructions stored as executable instructions stored in a computer system.

In yet another aspect of the invention there is provided a computer program product arranged to cause a processor to execute the method of the first aspects.

This aspect of the invention is particularly, but not exclusively, advantageous in that the present invention may be implemented by a computer program product enabling a computer system to perform the operations of the first aspect of the invention. Thus, it is contemplated that a DSS may be changed to operate according to the present invention by installing a computer program product on a computer system controlling the DSS. Such a computer program product may be provided on any kind of computer readable medium, e.g. magnetically or optically based medium, or through a computer based network, e.g. the Internet.

In yet another aspect of the invention there is provided a medical workstation comprising
the decision support system according to the invention;
a display device operatively connected to the decision support system for displaying the set of probabilities of interest to a user.

This aspect of the invention allows the decision support system to be used in a clinical environment. In such an environment, a user, for example a radiologist, may apply the decision support system to a set of observed symptoms from a patient. The decision support system may then derive the set of probabilities as an indication for possible causes for the observed symptoms and thereby enable the radiologist to arrive at a diagnosis.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIGS. 1A and 1B illustrate Bayesian networks in accordance with embodiments of the present invention;

FIG. 2 illustrates a schematic representation of a part of a Bayesian network in accordance with the present invention;

FIG. 3 illustrates a flow diagram of implementations of the present invention;

FIG. 4 schematically illustrates an implementation of a decision support system; and

FIG. 5 illustrates an overview of a specific implementation of a DSS in accordance with the present invention in a given situation of use.

### DESCRIPTION OF EMBODIMENTS

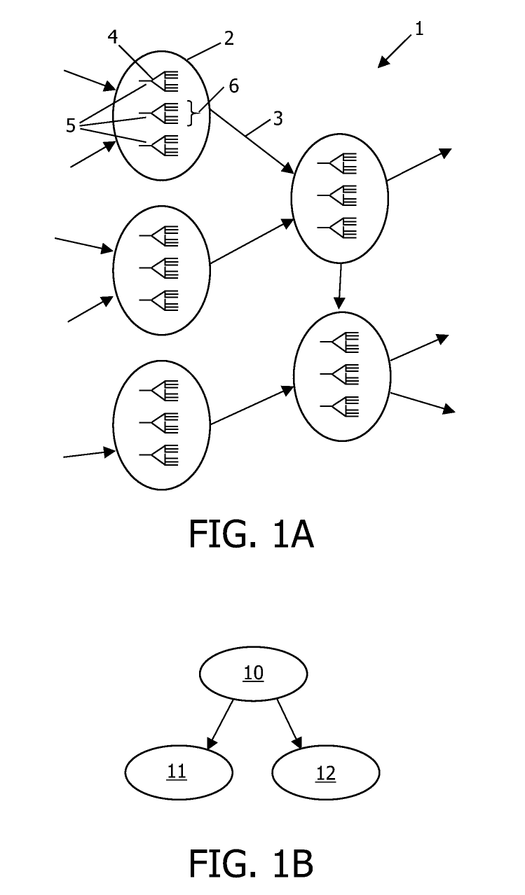

FIG. 1A illustrates a Bayesian network 1 in accordance with embodiments of the present invention. The Bayesian network 1 comprises a plurality of nodes 2 with associated probability parameters 4, the nodes being interconnected by directed arcs 3. An arc from one node to another may denote that an event represented by the former node can cause an event represented by the latter node with an associated conditional probability (CP), which is stored as a parameter of the latter node. The absence of arcs between two nodes indicates statistical independence of these nodes. Each node can have zero or more parent nodes and/or zero or more child nodes.

In the illustrated embodiment, all the nodes store three parameters 5, each parameter being stored as a value range 6. It is to be understood, that only at least a subset of the parameters may store value ranges. Thus a part of the nodes may store some, none or all of parameters as value ranges.

FIG. 1B illustrates another embodiment of a Bayesian network in accordance with the present invention. The network models the statistical relationship between smoking, cancer and high blood pressure and may be used in a medical workstation in a clinical environment. The node 10 is associated with parameters relating to smoking, the node 11 is associated with parameters relating to cancer, and the node 12 is associated with parameters relating to high blood pressure.

The node 10 stores two parameters, each stored as a value range, where the value range representing the uncertainty, i.e. the probability of the parameter:

P(Smoking=Yes)=[0.09; 0.11] representing the uncertainty that smoking is Yes,

P(Smoking=No)=[0.89; 0.91] representing the uncertainty that smoking is No.

The node 11 stores four parameters, each stored as a value range:

P(Cancer=Yes Smoking=Yes)=[0.59; 0.61]

P(Cancer=No Smoking=Yes)=[0.39; 0.41]

P(Cancer=Yes Smoking=No)=[0.19; 0.21]

P(Cancer=No Smoking=No)=[0.79; 0.81]

and the node 12 stores four parameter, each stored as a value range:

P(Bp=High Smoking=Yes)=[0.69; 0.71]

P(Bp=Low Smoking=Yes)=[0.29; 0.31]

P(Bp=High Smoking=No)=[0.39; 0.41]

P(Bp=Low Smoking=No)=[0.59; 0.61]

In this example, each parameter stores a value range of 0.02. It is to be understood however that each parameter may store a specific range, so that different parameters may store different ranges. It is also to be understood that not all nodes necessarily store a parameter range.

For a Bayesian network of the prior art, e.g. node 10 would store two parameters, each stored as a single value:

P(Smoking=Yes)=0. 1

P(Smoking=No)=0.9

And likewise for the nodes 11 and 12.

It is understood that any instantiation of parameters chosen from within the respective value ranges is such that the parameters for the probabilities P(Xᵢ=xᵢ₁ . . . xᵢₖ|PAᵢⱼ) are always larger than zero, smaller than one, and sum up to exactly one, where variable Xᵢ has k states and PAᵢⱼ refers to the jₜₕ of all possible combinations of states of the parents of node Xᵢ (PAᵢⱼ= when X has no parents).

When a node is observed to be in a certain state, the probabilities for all other nodes to be in their respective states given this evidence can be calculated from the Bayesian network. From this calculation, which is called inference, one can then find the most likely cause for the given set of observations (that together constitute the evidence). Conversely, one can calculate which observation is recommended to increase the certainty about a target node being in a target state the most. These two operations underlie Bayesian network based diagnosis.

Bayesian networks of the prior art store only a single value for each parameter, and the joint probability of variable X(1), . . . , X(n) to be in a given state is given as the product of P[X(i)|parents ((X(i))] for i=1 to n, where P[X(i)|parents ((X(i))] is determined from Bayes' theorem. The parameters of each node are the best estimates that the network designers obtained for their true values.

In the present invention, a value range is stored for at least a subset of parameters, each value range representing the uncertainty of the parameter; and probabilities of interest are calculated for parameter values chosen within their uncertainty range.

In an embodiment, the range of probability parameters is stored in terms of a minimum parameter value, Pi,min, and a maximum parameter value, Pi,max.

In another embodiment, the set of parameter ranges further includes storing a default parameter value, Pi,def The default values are the best estimates of the true parameter values.

In yet another embodiment, the value range of each parameter is stored in terms of a default value, Pi,def, and a deviation from the default value, ΔPi. In this embodiment Pi ranges from Pi,def−ΔPi to Pi,def+ΔPi.

In yet another embodiment, the value range of each parameter is expressed in terms of a positive deviation, ΔPi,pos and a negative deviation, ΔPi,neg. In this embodiment Pi ranges from m Pi,def−ΔPi,neg to Pi,def+ΔPi,pos.

In the latter two embodiments, the ΔPi's could be assigned for the entire network as a relative deviation (e.g. 5% or +5% and −10%) or an absolute deviation (e.g., 0.01, or +0.01 and −0.02) from the default value. These deviations could be user-defined, allowing users to experiment with uncertainty assumptions.

Moreover, combinations of the above embodiments are possible.

The number of values in each range could be infinite (continuous range) or finite (specified values only); in the latter case, a finite number of combinations of parameter values exists. Moreover, the probability distribution over the value range between the indicated minima and maxima may be uniform or non-uniform. As a non-uniform distribution, a Gaussian distribution centered around the default value could for example be used (asymmetric non-uniform distributions can also be envisioned). The various parameters mentioned above must be established during the design of the network.

In general may the parameters include such parameters as probability values (e.g. maximum values, minimum values, default values), values indicating the size of a range, deviations from default values, number of intervals in a range, etc. A specific set of prior probability parameters depends upon a specific embodiment of the invention.

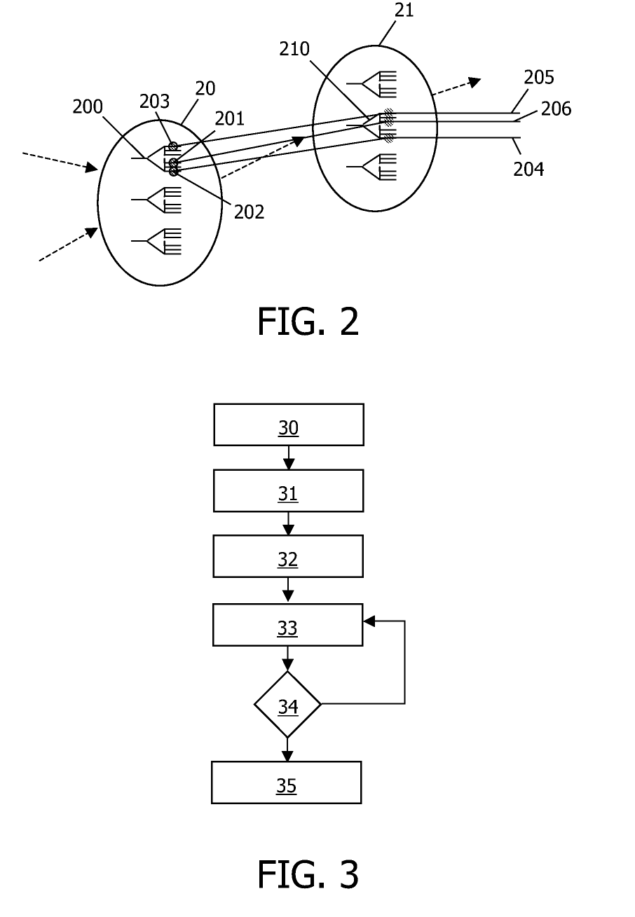

FIG. 2 illustrates a schematic representation of a part of a Bayesian network in accordance with the present invention. In the Figure, two nodes 20, 21 which take part of a decision process are shown. For each node 20, 21 parameters 200, 210 are provided, where the value range is illustrated as a distribution of a numbers with a default value 201, a minimum value 202 and a maximum value 203. The stored values of the set of parameters may be the maximum, minimum and default values. The system may from these values be implemented to generate the values of the present example.

FIG. 3 illustrates a flow diagram of implementations of the present invention.

In embodiments, may the set of probabilities of interest be obtained by setting all parameters of the Bayesian network to at least a first set of values and calculating the at least first set of values for the probabilities of interest, and setting all parameters of the Bayesian network to at least a second set of values and calculating at least a second set values for the probabilities of interest, the first and at least second set of parameter values being within the corresponding value ranges. At least one set of the at least two sets of parameter values may be set to random values within the value range.

Specific embodiments may be implemented by the following steps. First, the probabilities of interest are determined 30, and an initial set of parameter values is selected. The values of the probabilities of interest are then calculated in a number of steps via normal inference based on Bayes' theorem.

In step one denoted 31, the probabilities of interest are calculated from setting all Pi's to their minimum value. This is illustrated in FIG. 2 by the path indicated with reference numeral 204.

In step two denoted 32, the probabilities of interest are calculated from setting all Pi's to their maximum value. This is illustrated in FIG. 2 by the path indicated with reference numeral 205.

In step three denoted 33, the probabilities of interest are calculated from setting all Pi's to a random value between the minimum and maximum values. This is illustrated in FIG. 2 by the path indicated with reference numeral 206.

The third step denoted 34 is repeated N−2 times, giving a total of N inferences with randomized values of the prior probabilities, since there are N−2 inferences with random parameters plus 2 with predetermined parameters (min, max). The value of N should be as large as possible while preserving an acceptable response time. N could also be made adaptive, in the sense that the system repeats inference with randomized values of the parameters until a predefined period of time (e.g., one second) has elapsed, so that the uncertainties in the probabilities of interest are determined from the number of parameter value sets as can be evaluated in the predetermined period of time. The predetermined period of time may depend upon a user-setting in combination with the calculation speed of the system.

Each of the calculations illustrated by paths 204-206 provides a probability of interest, thereby forming a set of probabilities of interest. In step four denoted 35, the minimum and maximum values obtained by the above procedure are marked, thereby providing a set of probabilities of interest expressing the uncertainty of the probability of interest for a given event.

It is to be understood, that not all embodiments necessarily include all of the above-described steps, likewise other or alternative steps may be used, and steps may be added.

Step four 35 may be used, since step one 31 and two 32 not necessarily yield the minimum and maximum posterior probabilities. In an embodiment, step one and/or two are optional. In another embodiment, step three and four are optional, or other steps could be added. As an example of alternative steps that could be added, Pi's<0.5 could be set to their minimum and Pi's>0.5 to their maximum, and vice versa.

Due to the randomization, however, there is no guarantee that the absolute minimum and maximum value of the posterior probabilities of interest will be obtained. The estimated uncertainty may possibly be improved by setting each Pi not to a random value within the allowed range, but randomly to the minimum or maximum value. Moreover, one could change the values of the prior probabilities only of nodes that are in the sensitivity set if this leads to a larger N in the allotted time frame. One could also deploy a search algorithm that aimed at finding the maximum uncertainty of each probability of interest.

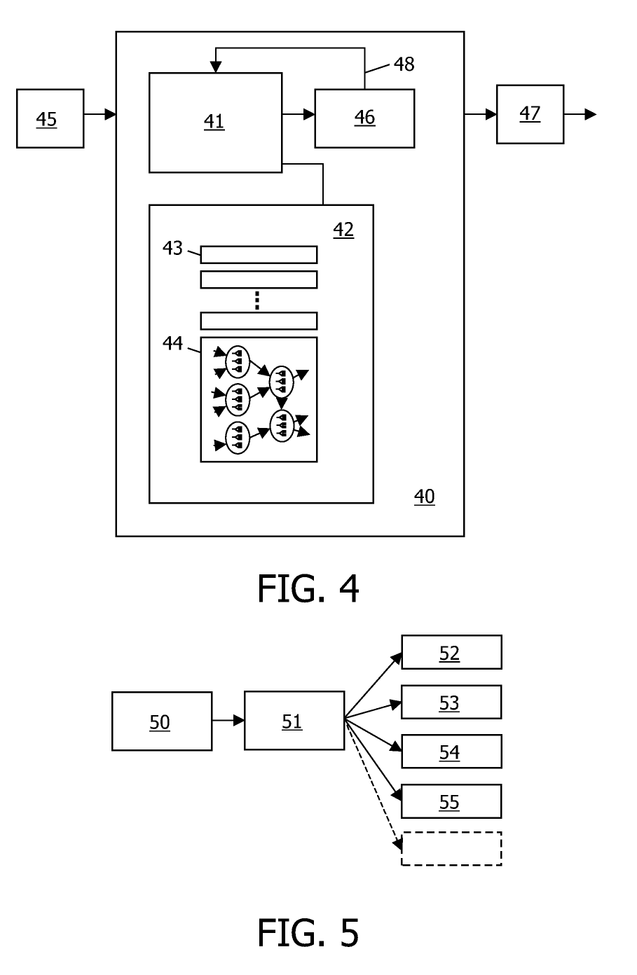

FIG. 4 schematically illustrates an implementation of a decision support system 40. The system comprises a processor 41 coupled to a memory 42 having executable instructions 43 stored therein. The memory stores at least one Bayesian network 44 in accordance with the present invention. The processor 41 is instructed to, in response to an input 45 to calculate a set of probabilities 46 of interest based on the set of parameters. The input 45 may be provided as a user-input or from a system such as a general or specific purpose computing system. The decision support system generates an output 47 based on the set of probabilities of interest 46, or alternatively outputs the set of probabilities of interest itself. The output may be presented to a user.

In an embodiment, the calculated set of probabilities of interest is inputted 48 into the processor for further treatment. The treatment may include preparation of the output 47 for suitable presentation. The treatment may also include a computation of whether the calculated set of probabilities of interest should influence the further behavior of the DSS. In an example, a check of the calculated probabilities of interest may be performed so as to ensure that large calculated uncertainties are not presented to a user, the user instead being shown a message, such as “Recommendation not Available”, instead of the normal output.

FIG. 5 illustrates an overview of a specific implementation of a DSS in accordance with the present invention in a given situation of use.

The DSS may be a system for supporting medical diagnostics or other medically oriented decisions. A user may be presented with a user-interface for inputting a set of observations. For example, test results, such as blood samples, medical images, etc. The system is typically a customized system where a specific user-interface is provided for inputting observations into a Bayesian network adapted to handle a specific kind of observations. The DSS calculates in accordance with the present invention the set of probabilities of interest in order to help the user or DSS system identify the most likely cause(s) for the given set of observations.

In accordance with the present invention, the inferred probabilities are not indicated to the user as a single value, but as values for each probability of interest thereby conveying also the uncertainty of the probability of interest to the user.

The result, e.g. expressed as P(A=a|obs), i.e. as the probability that A=a with a given set of observations (obs), may as a non-exclusive list be shown to a user as:
A range 52; e.g. P(A=a|obs) =0.89 . . . 0.95, possibly along with the default value, (e.g. 0.91);
As a default value and a variance 53; e.g. P(A=a|obs)=0.91±0.03;
As a graphical representation 54 of the posterior probability distribution between minimum and maximum values;
As a combination 55 of the above or other.

In general the set of probabilities of interest may consist of maximum values, minimum values, default values, values indicating the size of a range, deviations from default values, number of intervals in a range, etc. A specific set of probabilities of interest depends upon a specific embodiment of the invention.

When a small value range is obtained, users can confidently base their decision on the probability (range) presented by the system. Likewise, when the value range is large, they know that the inferred probability is highly uncertain and they should in that case not rely on the system for making their decision.

Embodiments of implementations have been provided, however the invention can be implemented in any suitable form including hardware, software, firmware or any combination of these. Especially, the invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method of operating a decision support system, the system comprising:
at least one Bayesian network (1), the at least one Bayesian network comprising a plurality of nodes (2, 20, 21), each node associated with parameters (4, 200, 210) expressing prior probabilities; wherein at least a subset of the parameters stores a value range (6); and wherein a set of probabilities of interest are calculated based on the parameters.

2. The method according to claim 1, wherein each value range (6) represents an uncertainty associated with the corresponding parameter.

3. The method according to claim 2, wherein each value range is stored in terms of a minimum value (202) and a maximum value (203).

4. The method according to claim 3, wherein each value range further includes a default value (201) falling within the range of the minimum value and maximum value.

5. The method according to claim 2, wherein each value range is stored in terms of a default value and a deviation from the default value.

6. The method according to claim 5, wherein the deviation from the default value is expressed in terms of a positive deviation and a negative deviation.

7. The method according to claim 2, wherein the probability distribution over the value range is uniform or non-uniform.

8. The method according to claim 1, wherein the calculation of the set of probabilities of interest includes calculating one or more values for expressing the uncertainty of the probability of interest.

9. The method according to claim 8, wherein the uncertainties of the set of probabilities of interest is obtained by setting all parameters of the Bayesian network to at least a first set of values and calculating at least a first probability of interest, and setting all parameters of the Bayesian network to at least a second set of values and calculating at least a second probability of interest, the first and at least second set of values being within the value range of the parameters.

10. The method according to claim 9, wherein at least one set of the at least second set of values is set at random values within the value range of the parameters, or set at values chosen by a search algorithm.

11. The method according to claim 8, wherein a predetermined period of time is set, and where the uncertainties in the probabilities of interest are determined from the number of parameter value sets as can be evaluated in the predetermined period of time.

12. A decision support system (40) comprising
a processor (41);
a memory (42) having executable instructions (43) stored therein;
at least one Bayesian network (44) stored in the memory, the at least one Bayesian network comprising a plurality of nodes, each node associated with parameters expressing prior probabilities; wherein at least a subset of the parameters stores a value range
wherein the processor, in response to instructions calculates a set of probabilities of interest based on the parameters.

13. A computer program product arranged to cause a processor to execute the method of claim 1.

14. A medical workstation comprising
the decision support system according to claim 12,
a display device operatively connected to the decision support system for displaying the set of probabilities of interest to a user.
